(19) United States
(12) Patent Application Publication
(10) Pub. No.: US 2011/0273867 A1
(43) Pub. Date: Nov. 10, 2011

(54) ADJUSTABLE SHELVES WITH LIGHTING FIXTURE

(75) Inventors: Sheldon L. HORST, Columbia, PA (US); Nevin G. Dagen, Lititz, PA (US)

(73) Assignee: PREMIER CUSTOM BUILT, INC., New Holland, PA (US)

(21) Appl. No.: 13/100,376

(22) Filed: May 4, 2011

Related U.S. Application Data
(60) Provisional application No. 61/331,587, filed on May 5, 2010.

(51) Int. Cl. F21V 33/00

(52) U.S. Cl. 362/133

(57) ABSTRACT

An adjustable lighted shelf and a cabinet having at least one adjustable lighted shelf. The cabinet has power strips attached to a low voltage power supply. Shelf supports are provided for mounting the at least one adjustable shelf in the cabinet. The at least one adjustable shelf has a lighting fixture and contact assemblies. The contact assemblies are in electrical engagement with the lighting fixture and the power strips. The contact assemblies have contacts which extend outward from the adjustable shelf to make electrical engagement with the power strips.

### FIELD OF THE INVENTION

The present invention relates generally to methods and apparatus for the display of items in a residential, office, commercial, or retail environment, and more particularly to a display or storage system including shelves having a low voltage light fixture mounted underneath.

### BACKGROUND OF THE INVENTION

Light-emitting diode (LED) based lighting has emerged over the last few years as a high efficiency, long life, low power and low voltage light source for many lighting applications ranging from television screen backlights, signage lighting, architectural lighting and so on. Of particular relevance to the kitchen cabinet manufacturing industry, LED lighting products have become available in strip and puck form. A puck is a single LED or a cluster of LED's arranged in a circular-faced fixture to simulate a conventional point source illumination product such as a halogen, xenon or incandescent spotlight. A strip is a long narrow arrangement of individual LED's spread out over the length of the strip on a regular pitch, typically ranging from ½ inch to 1 inch where the overall length of available rigid strip products ranges from 5 inches to 20 inches or in flexible strip rolls in lengths of 5 inches or more which can be cut to the desired length. Individual rigid strip products are often designed to be end-to-end mate-able by way of an interconnect system so as to allow the overall length of the strip light to be extended to typical lengths ranging from 2 feet to 4 feet and in many cases much longer. Flexible LED strips support equivalent lengths without the need for intermediate connections along the length of the installed strip. There is an ever-expanding commercial offering of strip and puck LED lighting products.

Both strip and puck LED lighting formats have practical application in the construction of furniture and cabinetry. Lighting traditionally is applied in furniture and cabinetry in three primary areas: valence accent lighting located above the cabinets, under-cabinet lighting used to light the counter tops and work surfaces, and interior lighting used to illuminate the interior of the cabinet and its contents.

Furniture pieces such as china cabinets and butler's pantries typically incorporate transparent glass in both doors and shelves and are often built to include interior lighting to highlight the display. Due to the transparency of glass shelves in these kinds of cabinets, the light source which is most often mounted in the top interior surface is able to provide light down through the multiple shelves to illuminate reasonably well even the contents of the lower portion of the cabinet.

However, the majority of cabinetry does not include glass doors or shelves. In general cabinetry includes a mix of product, some that have solid shelving and solid doors and some that have glass paneled doors and shelves. In all cases the aesthetic appeal of cabinetry is improved with the addition of interior cabinet lighting, and the result is desirable to clientele.

Cabinets often include shelves to increase the storage area of the cabinet. Shelves can be fixed or adjustable. Adjustable shelves allow the cabinet to be configured to the nature and size of its contents. Applying LED lighting or other lighting systems to the interior of a cabinet containing adjustable shelves allows for several options of light fixture placement. A strip light can be mounted horizontally to the top interior surface of the cabinet projecting downward or to any other horizontal fixed shelf or horizontally oriented fixed partition. The disadvantage to placing light strips mounted horizontally in cabinetry is that if a shelf is placed underneath the light source, the shelf becomes a block to the light and prevents or shadows the light from being able to project into areas of the cabinet below the adjustable shelf.

Mounting strip lighting vertically oriented into the interior side walls of the cabinet addresses the issue of impeded light projection by adjustable shelves. However, the contents of the cabinet, if placed in close proximity to the side interior walls of the cabinet containing vertically oriented strip lighting, will produce a similarly undesirable shadowing affect. Secondarily, the aesthetic quality of vertically oriented light strips is a drawback as it presents an unnatural, lateral direction of light projection.

Lighting the interior of cabinetry containing adjustable shelves can also be accomplished by mounting strip lighting horizontally to the adjustable shelves. In doing so, each shelf containing a light strip is able to illuminate the area immediately adjacent to it and the issue of shadowing or blocking of light projection is resolved. However, providing lighting on adjustable shelves poses an issue of providing the power required in an economical and aesthetically pleasing manner.

U.S. Pat. Nos. 4,973,796 and 5,425,648, disclose vertical shelf standards including internal conductors. The conductors are housed within the standards in such a way that an ordinary shelf bracket would not contact the conductors. Specially designed couplers include spring wires or clips that contact the internal conductors when the coupler is inserted into the shelf standard. In a cabinet or display unit according to either of these patents, an illuminated shelf may be inserted into and supported by a pair of shelf standards, and a special electrical coupler cabled to a light fixture may be inserted into one of the shelf standards just below the shelf itself to help minimize cable exposure.

While the aforementioned patents solve the problem of providing power to shelf light fixtures, they involve the use of shelf standards and connectors that are electrically and mechanically complex and are therefore more costly to manufacture than conventional shelf standards, and are more susceptible to failure due to mechanical fatigue and wear. Furthermore, electrical connections to the internal conductors of the shelf standards are made by a separate, specially designed connector located adjacent to, but not integral with, a supporting bracket for an illuminated shelf, so the power cord is not entirely hidden from view.

U.S. Pat. No. 6,231,205 discloses a display case is provided having vertical members with internal conductors. The conductors are coupled to a source of low voltage electrical power such that adjacent vertical members are of differing electrical polarity. Shelf supports are designed to make electrical contact with the internal conductors when engaged in a vertical member. A light fixture disposed on the underside of a shelf is electrically coupled to the shelf supports, thereby completing an electrical circuit for energizing the light fixture. Sides include power strips mounted into a groove or slot therein. The sides include a number of holes spaced apart for accepting conventional shelf support pins. The power strips also include a number of spaced apart holes corresponding to spaced apart holes for accepting conventional shelf support pins. Together, the holes accept steel pins to support shelves which may contain under-shelf light fixture.

In view of the foregoing, it would be desirable to provide a system of illuminated shelving wherein electrical connections for energizing the illuminated shelves do not detract from the aesthetic appeal of the system. It would also be desirable to provide a system of illuminated shelving wherein the components thereof are electrically and mechanically simple in design and therefore relatively inexpensive to manufacture.

### SUMMARY OF THE INVENTION

In consideration of interior lighting, cabinets are not unlike an automobile or a refrigerator. When the doors are opened, it is desirable to have a light come on. Cabinets with adjustable shelves are lighted beautifully when the adjustable shelves are outfitted with strip lights to illuminate the area beneath (and/or above) the shelves. A means of interconnecting the lighted adjustable shelf to a power supply is described by the invention. A class II power supply, possessing no shock or fire hazard, is connected to a pair of electrically conductive power strips mounted in the interior of the cabinet vertically along the height of the cabinet. Adjustable and removable shelves are outfitted with a light strip(s) and typically two plunger contacts, and wires connecting the plunger contacts to the light strip(s). The shelf is installed into the cabinet and the plunger contacts are compressed by interface to the power strips contained within the cabinet, and electrical power is transmitted from the power strips to the plunger contacts and therefore into the lighting strip(s) contained within the adjustable shelf. The adjustable lighted shelf is able to be freely removed and installed and able to have its position adjusted along an unlimited range inside the cabinet by the very same means as a non-lighted adjustable shelf. No deliberate interconnection step is required when removing, installing or adjusting the lighted shelf.

An exemplary embodiment describes an adjustable shelf for mounting in a cabinet. The adjustable shelf has a top surface and a bottom surface, the bottom surface having a recess provided therein for receiving a lighting fixture. Sidewalls extend between the top surface and the bottom surface; the sidewalls or back wall having openings which extend therethrough. A lighting fixture is mounted in the recess of the bottom surface. Plunger contact assemblies are mounted in the openings of the sidewalls or back wall, with the plunger contact assemblies being in electrical engagement with the lighting fixture. The plunger contact assemblies have plunger contacts which extend outward from the sidewalls or back wall and can be resiliently depressed toward the sidewalls or back wall as the adjustable shelf is positioned in a cabinet. The plunger contact assemblies are independent of mounting means which mount the adjustable shelf to the cabinet, thereby providing unlimited position adjustability of the shelf without requiring intentional coupling or decoupling of electric power.

An exemplary embodiment describes a cabinet having at least one adjustable shelf. The cabinet has power strips attached to a low voltage power supply. Shelf supports are provided for mounting the at least one adjustable shelf in the cabinet. The at least one adjustable shelf has a lighting fixture and contact assemblies. The contact assemblies are in electrical engagement with the lighting fixture and the power strips. The contact assemblies have contacts which extend outward from the adjustable shelf to make electrical engagement with the power strips.

An exemplary embodiment describes a cabinet having at least one adjustable shelf. The cabinet includes power strips attached to a low voltage power supply and shelf supports for mounting the at least one adjustable shelf in the cabinet. The at least one adjustable shelf has a top surface and a bottom surface, with the bottom surface having a recess provided therein for receiving a lighting fixture, Sidewalls extend between the top surface and the bottom surface. The sidewalls or back wall have openings which extend therethrough. A lighting fixture is mounted in the recess of the bottom surface. Contact assemblies are mounted in the openings of the sidewalls or back wall, with the contact assemblies being in electrical engagement with the lighting fixture and the power strips. The contact assemblies have contacts which extend outward from the adjustable shelf to make electrical engagement with the power strips. The contact assemblies are independent of the shelf supports, thereby providing unlimited position adjustability of the at least one adjustable shelf without requiring intentional coupling or decoupling of electric power.

The invention describes a shelf with lighting contained therein and a method by which strip lights mounted to adjustable shelves are able to conform to the desires of clientele by eliminating visible wires, by providing unlimited position adjustability of the shelf or shelves, and by allowing the shelf to be removed or installed in the identical way as an adjustable shelf without a light—that is to say, no intentional coupling or decoupling of the electric power interconnection is required by the client—the simple act of installing or adjusting the shelf is enough to accomplish the power connection.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 is a front perspective view of an exemplary embodiment of a cabinet with an adjustable lighted shelf;

FIG. 2 is a close-up perspective view of the exemplary cabinet of FIG. 1 illustrating an exemplary adjustable lighted shelf and a power strip;

FIG. 3 is a bottom perspective view of an exemplary adjustable shelf illustrating a lighting fixture mounted therein;

FIG. 4 is a cross-sectional view taken along line 4-4 of FIG. 3.

FIG. 5 is a side view of the shelf of FIG. 2 showing one embodiment of a plunger contact inserted therein;

FIG. 6 is a diagrammatic view of the shelf of FIG. 2;

FIG. 7 is a diagrammatic view of an alternate exemplary embodiment of an adjustable shelf having two contacts located on one side of the shelf;

FIG. 8 is a diagrammatic view of an exemplary cabinet into which the shelf of FIG. 7 is inserted, the phantom lines representing the insertion motion of the shelves into the cabinet;

FIG. 9 is a diagrammatic view of an additional alternate exemplary embodiment of an adjustable shelf having two contacts located on the rear of the shelf;

FIG. 10 is a diagrammatic view of an exemplary cabinet into which the shelf of FIG. 9 is inserted, the power strips located on the back wall of the cabinet;

FIG. 11 is a top view of an exemplary contact which can be inserted into a shelf;

FIG. 12 is a cross-sectional view of the contact of FIG. 11 taken along line 12-12 of FIG. 11;

FIG. 13 is a top view of an alternate exemplary contact which can be inserted into a shelf;

FIG. 14 is a top view of an alternate exemplary contact which can be inserted into a shelf;

FIG. 15 is a cross-sectional view of the contact of FIG. 14 taken along line 15-15 of FIG. 14;

FIG. 16 is a partial cross-sectional view of an alternate exemplary contact which can be inserted into a shelf;

FIG. 17 is a partial cross-sectional view of an alternate exemplary contact inserted into a shelf;

FIG. 18 is a partial cross-sectional view of an alternate exemplary leaf spring contact inserted in a shelf; and

FIG. 19 is a perspective view of an exemplary adjustable shelf with a glass portion.

### DETAILED DESCRIPTION OF THE INVENTION

Cabinets or display cases for displaying items are well known. In order to properly display the items, it is important that lighting be provided which properly illuminates all of the items being displayed. A cabinet interior containing one or more adjustable shelves is ideally lighted where strip lights are mounted horizontally on the underside of each adjustable shelf in addition to strip lights mounted horizontally in the top interior surface of the cabinet and strip lights mounted horizontally in any fixed shelves or any fixed horizontally oriented partitions.

Mounting strip lights in the top interior surface of the cabinet and in fixed shelves or fixed horizontally oriented partitions is readily accomplished by either machining a pocket or slot for the strip light to nest into or by mounting the strip light on the surface. In either case, the strip light will be held in a fixed position and the associated wires can be run through a wire chase, holes, slots or grooves, or secured appropriately to the various fixed interior or exterior surfaces of the cabinet to their eventual destination connection with power supply, switch or dimmer controls or other associated controls. Due to the fixed position of the mounted light strips, the light strips and associated wiring can be hidden or embedded in wire chase holes, slots or grooves in the cabinet parts, including cabinet returns (walls of cabinet construction) or floors (top, bottom of cabinet construction plus horizontally oriented fixed partition or fixed shelf). This produces a clean, uncongested, aesthetic quality to the interior of lighted cabinetry.

In the case of cabinetry containing one or more movable or adjustable shelves, it would be desirable to mount the strip lighting horizontally on or in the adjustable shelves in the same manner that strip lights can be mounted to fixed shelves and fixed floors. The dilemma faced in producing an adjustable shelf with a horizontally mounted strip light is that the associated wires powering the strip light are not easily hidden due to the need for the wires to follow the shelf as its position is adjusted. Furthermore, adjustable shelves are not only adjustable in position within the cabinet, they are removable. Previously, an adjustable shelf with light strip would require at least some exposed wire to follow the range of motion of the shelf and some disconnection means to allow the wires to be detached from the shelf when removing the shelf from the cabinet.

According to the exemplary embodiments described herein, an adjustable shelf and method are disclosed which allows for the strip lights mounted to the adjustable shelves in a manner to allow for the proper operation of the strip lights while eliminating visible wires, providing unlimited position adjustability of the shelf or shelves contained within a cabinet, and allowing the movable or adjustable shelf to be removed or installed into the cabinet in the identical way as a movable or adjustable shelf without a light—i.e., no additional steps of intentional coupling or decoupling of the electric power interconnection is required by the client—the simple act of installing or adjusting the shelf is enough to accomplish the power connection.

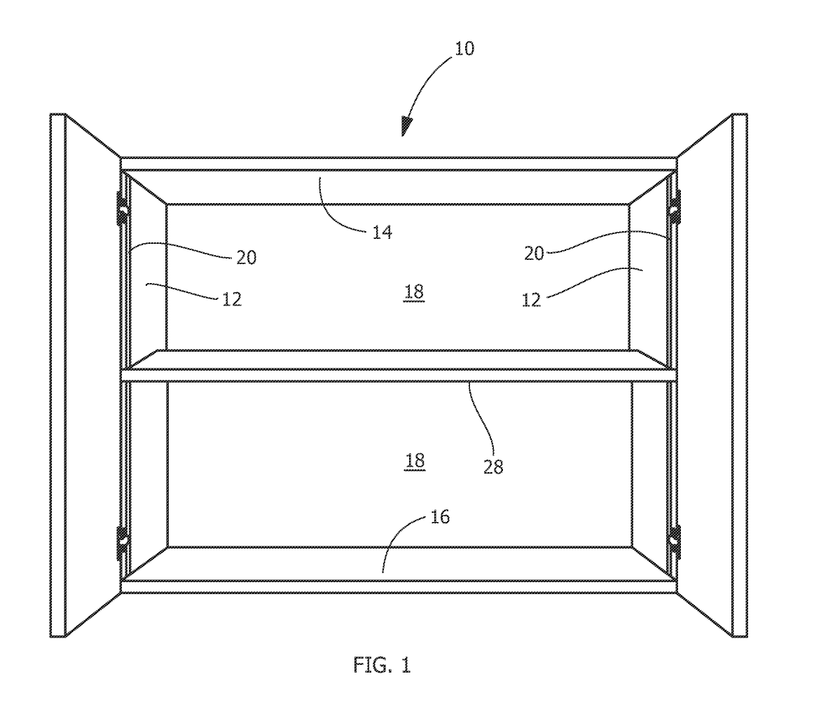

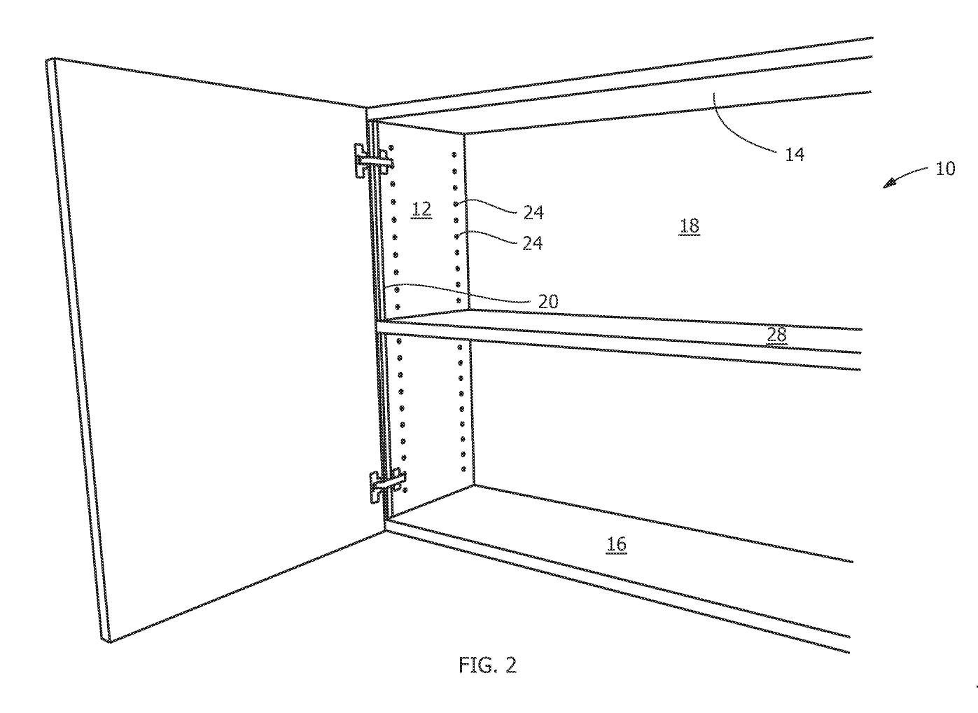

Referring first to FIGS. 1 and 2, a first illustrative embodiment of a cabinet 10 is shown. In this embodiment, the cabinet 10 is mounted to a wall; however, the cabinet may be either free standing or attached to a supporting structure. The cabinet 10 has side walls 12, a top wall 14, a bottom wall 16 and a back wall 18. Doors may be provided on the cabinet 10 on the surface opposite the back wall 18 or the cabinet may remain open. Side walls 12 include bus bars or power strips 20 mounted into a groove or slot 22 therein. Side walls 12 also include a number of spaced apart openings or holes 24 for accepting conventional shelf support pins 26 which support the movable or adjustable shelves 28. Alternatively, tracks may be provided which cooperate with tracks on the shelves 28 to permit the shelves 28 to be rolled into and out of the cabinet 10.

In the embodiment shown, the power strips 20 are positioned proximate to, but offset, from the openings 24. In alternate embodiments, the power strips 20 may be positioned in other locations on the side walls 12 or back wall 18 or other locations within the cabinet 10. It should be understood the perspective used in FIG. 1 hides one power strip from view, and that, in this embodiment, both side walls 12 of the cabinet 10 include a power strip 20.

Power for the cabinet 10 is provided by low voltage power supply (not shown), which converts line voltage to a low voltage of about 12 volts, but may be as high as about 24 volts depending on the number of lighted shelves installed in cabinet 10. The low voltage power supply is coupled to the power strips 20 by connector blocks or other known methods. Preferably, low voltage power supply is provided in a location which allows the power supply to be hidden from view.

As is known in the industry, the power supply is a class II power supply which may produce a maximum of 30 VDC and 2 Amps output and is internally protected against a full short condition so that in the event of a full short across the power supply, the power supply will recover undamaged and unaffected and able to produce its rated output after the short is removed. Many LED light strips commercially available are powered by class II power supplies. In the US, a class II power supply is connected to a wall outlet providing 120 VAC and converts the input voltage to an output voltage of 30 VDC or less and a maximum of 2 Amps. There is inherently no shock or fire hazard associated with the output of a class II power supply. A suitable power supply is available from Translite Systems, of San Carlos, Calif.

Referring to the exemplary embodiment shown in FIGS. 1 through 6, the movable or adjustable shelf or shelves 28 have top surfaces 29, bottom surfaces 31, side surfaces 43, back surfaces 45 and front surfaces 47. The shelves 28 are fitted with light fixtures or strips 30 which are position in cavities or recesses 32 of the bottom surface 31 of shelves 28. The light fixtures 30, which can be, for example, LEDs, are known in the industry. The light fixtures are generally held in place by frictional engagement or by compression of mounting means. The lighting fixtures and mounting methods are generally known in the industry.

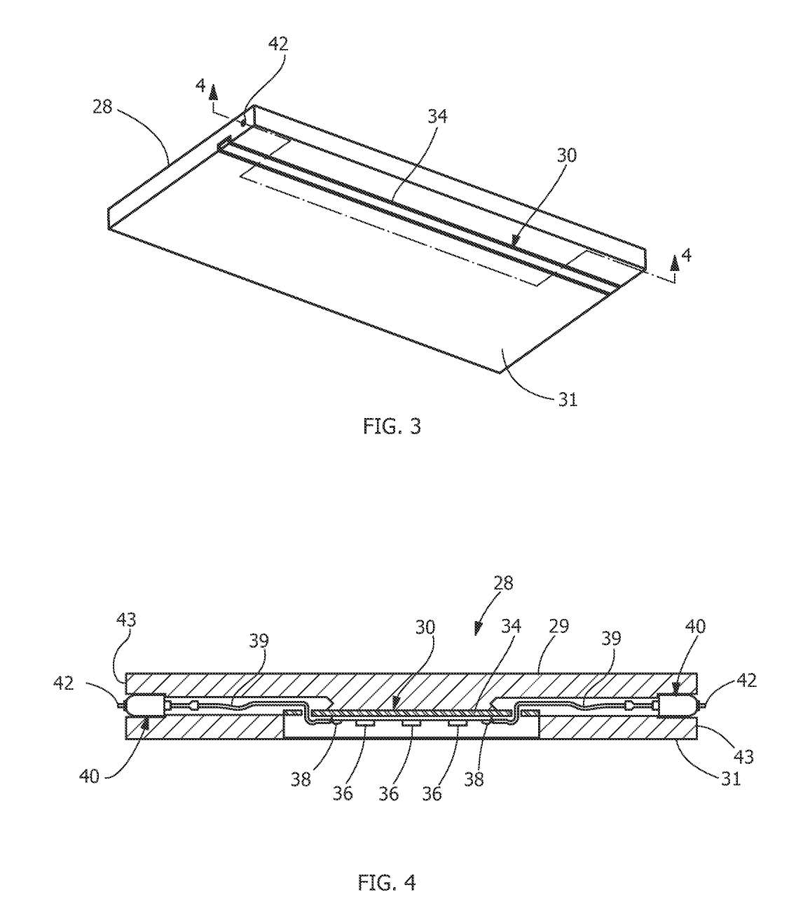

As exemplary embodiment of one such light fixture 30, which is shown in more detail in FIG. 3, includes base 34, lights or lamps 36, and electrical contacts 38 which are connected to wires 39. Each base 34 is mounted to a respective recess 32 of a respective shelf 28 and is attached to shelf 28 by means of mechanical fasteners or a suitable adhesive. Base 34 may be made of metal, such as extruded aluminum, ABS plastic, polycarbonate, PVC, or other suitably rigid material. Lights 36 have lens which are preferably a transparent polycarbonate extrusion designed to distribute the light provided by lights 36. To that end, lens may be smooth, textured, or faceted, and may be transparent, translucent, or partially opaque, depending on the specific lighting needs. For example, lens may include longitudinal grooves for focusing the light downward, and may include opaque portion to reduce the amount of horizontally projected light.

In the exemplary embodiment shown in FIGS. 1 through 6, each adjustable shelf 28 is fitted on either end with spring-loaded electrical plunger contact assemblies 40, such as, but not limited to pogo pins. The contact assemblies 40 are embedded into the shelf 28 so that only the movable portions 42 of the plunger contact assemblies 40 protrude from the shelf 28. The plunger contact assemblies 40 are soldered, crimped or otherwise attached to wires which are in turn connected to the light fixture 30 to conduct electrical power to the light fixture 30. Typically two wires are used to provide power to the light fixture 30, one for positive (+) and one for negative (−), and consequently two plunger contact assemblies 40 are typically employed within the shelf 28. Alternatively the contact assemblies 40 may be an integral component of the light fixture 30.

Corresponding to the typically two plunger contact assemblies 40 are the two conductive power strips 20 contained within the interior surfaces of the cabinet 10. The power strips 20 are mounted in a vertical groove milled in the cabinet 10 and provide a means of bringing electrical power to shelf 28. The power strips 20 are positioned to align to the placement of the contact assemblies 40 when the adjustable shelves 28 are fully inserted into the cabinet 10. The power strips 20 are constructed of an electrically conductive material, such as, but not limited to, brass, copper, stainless steel, copper-based nickel-silver, or any other material having good electrical and corrosion resistance properties and a pleasing appearance. The power strips 20 typically extend the length of the full height of the cabinet and are thin and narrow and oriented vertically within the interior side walls 12, also known as returns, of the cabinet 10. In an exemplary embodiment the power strips are approximately 0.03 inches thick and 0.25 inches wide.

One of the power strips 20 is designated to be a positive (+) electrical conductor and the other is designated to be a negative (−) electrical conductor. One set of power strips 20 installed in the cabinet 10 is able to supply multiple lighted adjustable shelves 28. As previously described, power is supplied to the power strips 20 by the lower voltage power supply. In various applications, other electrical control components such as an electro-mechanical door switch, Infrared door switch, optical-electric or capacitance-based touch switch, dimmer switch and so forth are integrated between the power supply and the power strips 20 to control when and how electrical power is supplied to the light fixtures 30.

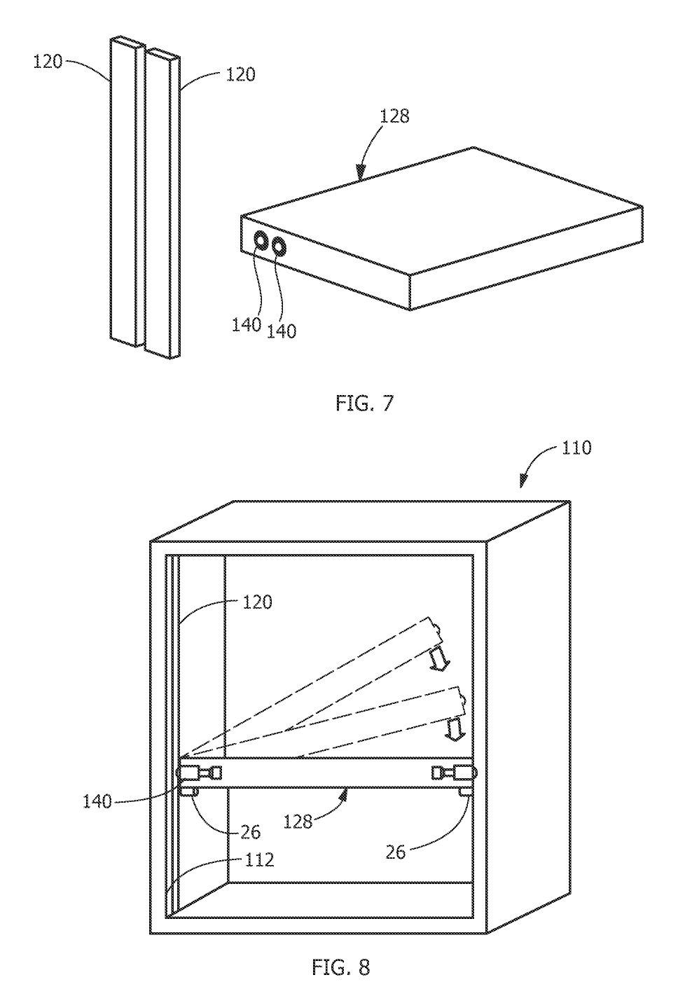

While FIGS. 1 through 6 illustrate contact assemblies 40 positioned on either side of shelves 28, other configurations may be used. Examples of such alternate exemplary embodiments are shown in FIGS. 7 though 10.

In FIGS. 7 and 8, two contacts 140 are positioned on the same side of shelves 128. This requires that two bus bars or power strips 120 be mounted on one side wall 112 of cabinet 110. In this embodiment, the shelves 128 may be inserted into the cabinet 110 and rotated as illustrated in FIG. 8.

In FIGS. 9 and 10, two contacts 240 are positioned on the back side of shelves 228. This requires that two bus bars or power strips 220 be mounted on a back wall 218 of cabinet 210. In this embodiment, the shelves 228 may be inserted into the cabinet 110 by sliding the shelves 228 toward the back wall 218.

As is evident from the exemplary embodiments, the power strips 20 can be mounted in the side walls 12 of the cabinet 10, the back wall 18 of the cabinet 10, on the inside surface of the face frame of the cabinet 10 or in other locations. The location of the power strips 20 may often be determined by considering where the power strips 20 are least visible; however, it has been found that the power strips 20 can be aesthetically pleasing and take on the appearance of a decorative accent strip within the cabinet interior.

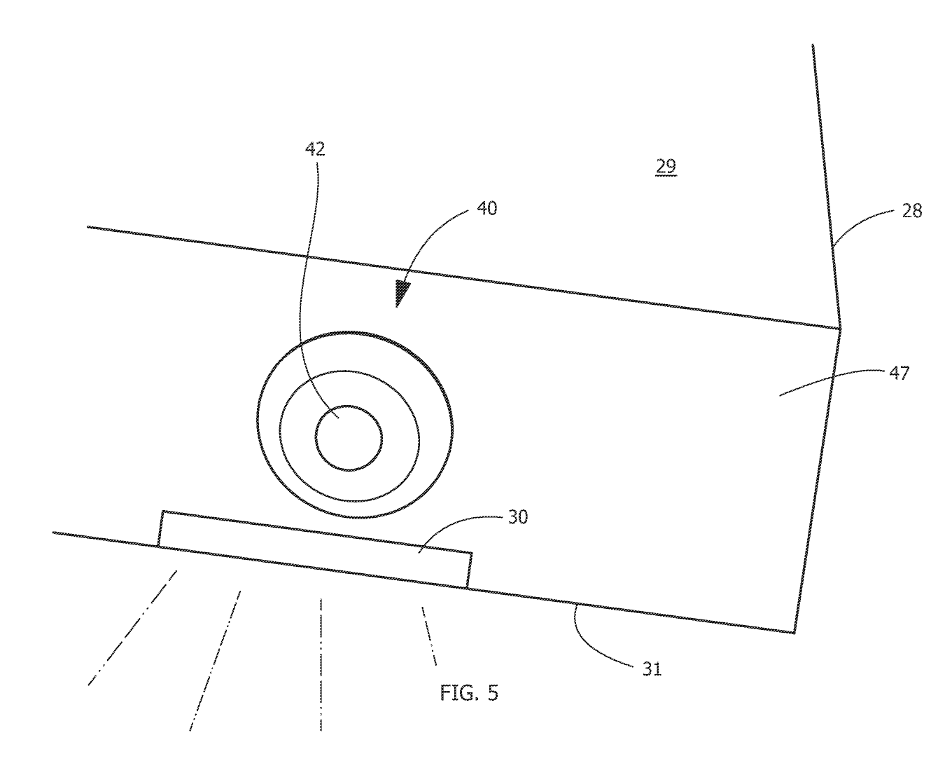

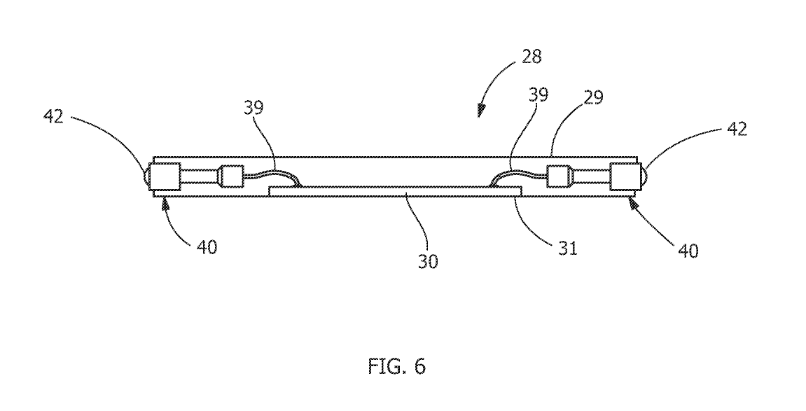

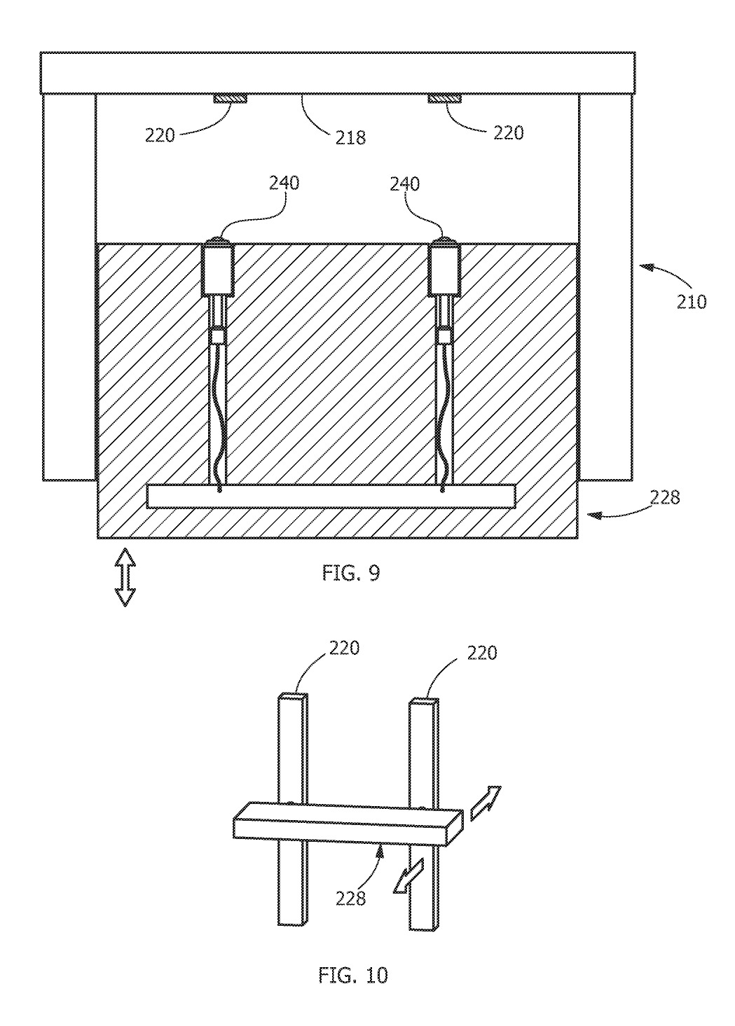

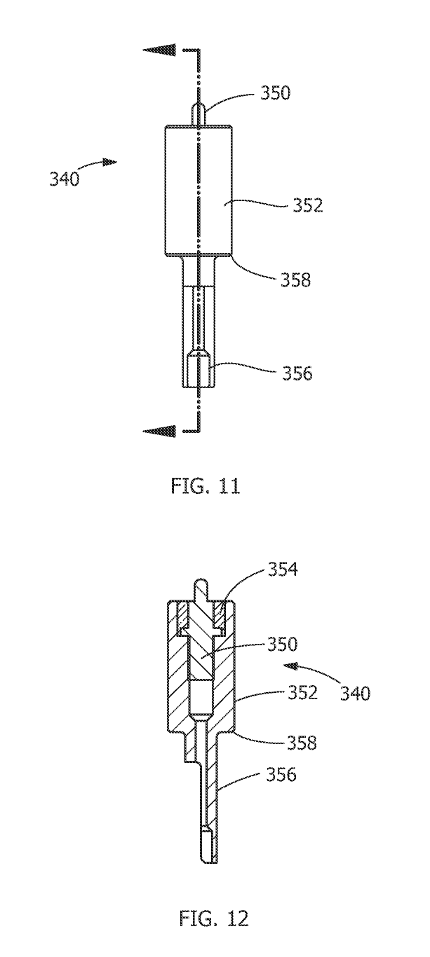

Contact assemblies 40 are positioned extend through the sides 43 of shelves 28 to make electrical contact with the power strips 20, as is best shown in FIG. 5. As shown in FIGS. 6 and 7, the contacts may extend from both sides 43 of the shelves 28 or may extend from only one side, depending upon the configuration of the power strips 20 and the manner in which the shelves 28 are to be inserted and removed. In addition, as shown in FIG. 9, the contact assemblies 40 may extend through the rear 44 of the shelves 28. Various embodiments of exemplary contacts are shown in FIGS. 11 through 17.

Referring to FIGS. 11 and 12, one exemplary contact assembly 340 includes a plunger contact 350 housed within a contact housing 352. In this exemplary embodiment, the plunger contact 350 is based upon a commercially available plunger contact produced by Mill-Max Mfg Corp. of Oyster Bay, N.Y. The contact housing 352 is made from a copper alloy or any other material having the conductive properties required. The contact housing 352 is designed to contain and permanently hold the plunger contact 350 by means of solder 354. A wire solder cup 356 is provided for securely attaching a wire which extends from the lighting fixture 30. Alternatively, a crimp barrel or other known means may be provided for securely attaching the wire to the contact 340. As shown in FIG. 4, the contact 340 is configured to have a stepped external profile to provide a shoulder 358 which cooperates with a surface 33 of a respective recess 32 of the shelf 28 to provide a stopping point to prevent over-inserting the plunger contact assembly 340 into the adjustable shelf 28.

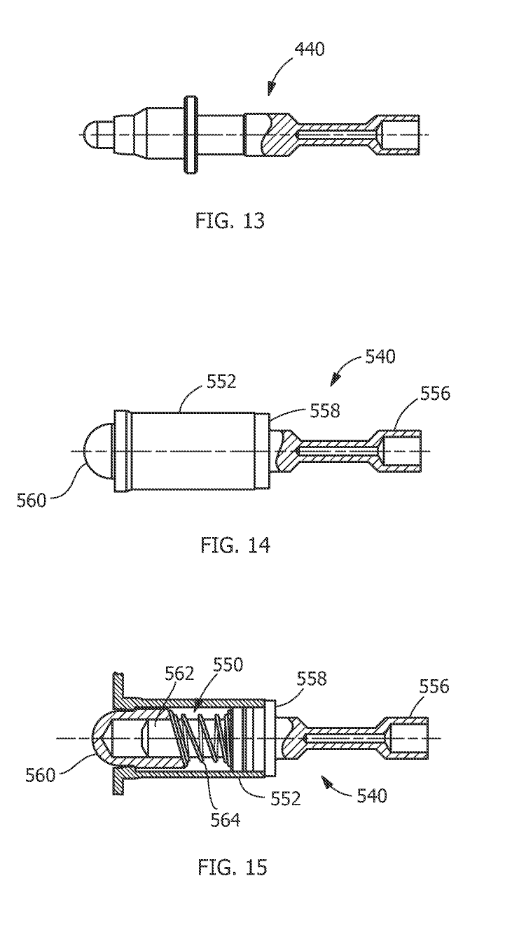

FIG. 13 illustrates another exemplary contact assembly 440. This contact assembly 440 has a different profile from the contact assembly 140 of FIG. 11, but operates in a similar fashion.

FIGS. 14 and 15 illustrate another exemplary contact assembly 540. The contact assembly 540 includes a plunger contact 550 housed within a contact housing 552. In this exemplary embodiment, the plunger contact 550 has an electrically conductive external member 560 and an electrically conductive internal member 562. A resilient spring 564 is provided to bias the external member 560 away from a wire attaching members 556. The external member 560 and the internal member 562 are in frictional engagement or otherwise electrically engaged, thereby allowing the power to be transmitted from the external member 560 to the internal member 562. The contact housing 552 may be made from plastic or any other material having the strength properties required. The contact housing 552 is designed to contain and permanently hold the plunger contact 550 by means of a shoulder 564. A wire attaching member 556 is provided for securely attaching a wire which extends from the lighting fixture 30. The wire attaching member 556 may be in the form of a solder cup, a crimp barrel or other know means for securely attaching the wire to the contact 540. As previously described, the contact 540 is configured to have a stepped external profile to provide a shoulder 558 which cooperates with a surface 33 of a respective recess 32 of the shelf 28 to provide a stopping point to prevent over-inserting the plunger contact assembly 540 into the adjustable shelf 28.

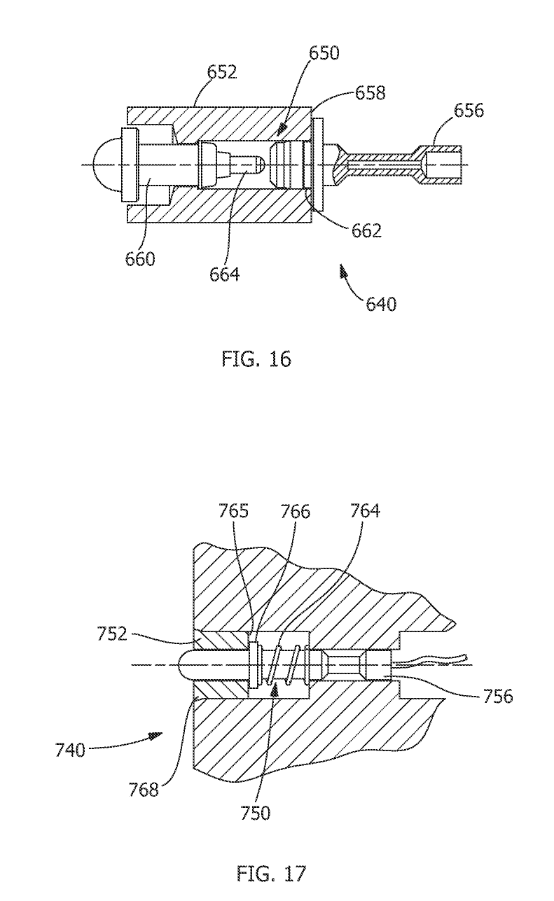

FIG. 16 illustrates another exemplary contact assembly 640. The contact assembly 640 includes a plunger contact 650 housed within a contact housing 652. In this exemplary embodiment, the plunger contact 650 has an electrically conductive external member 660 and an electrically conductive internal member 662. A movable pin 664 is provided to bias the external member 660 away from a wire attaching members 656. The external member 660 and the internal member 662 are placed in electrical engagement by the engagement of the pin 664 with the internal member 662, thereby allowing the power to be transmitted from the external member 660 to the internal member 662. The contact housing 652 may be made from plastic or any other material having the strength properties required. The contact housing 652 is designed to contain and permanently hold the external member 660 by means of a shoulder 664 and the internal member 662 by means of an interference fit. A wire attaching member 656 is provided for securely attaching a wire which extends from the lighting fixture 30. The wire attaching member 656 may be in the form of a solder cup, a crimp barrel or other know means for securely attaching the wire to the contact 640. As previously described, the contact 640 has a shoulder 658 which cooperates with a surface 33 of a respective recess 32 of the shelf 28 to provide a stopping point to prevent over-inserting the plunger contact assembly 640 into the adjustable shelf 28.

FIG. 17 illustrates another exemplary contact assembly 740. The contact assembly 740 includes a plunger contact 750 housed within a contact housing 752. In this exemplary embodiment, the plunger contact 750 has a resilient spring 764 which is provided to bias the plunger contact 750 toward the side 43 of shelf 28. The contact housing 752 may be made from plastic or any other material having the strength properties required. The contact housing 752 is designed to contain and permanently hold the plunger contact 750 by means of a shoulder 765. A wire attaching member 756 is provided for securely attaching a wire which extends from the lighting fixture 30. The wire attaching member 756 may be in the form of a solder cup, a crimp barrel or other know means for securely attaching the wire to the contact 340. The contact 750 is configured to have a shoulder 766 to cooperate with the shoulder 765 of the housing to maintain the contact 750 in position. The housing 752 has a flared lip 768 which cooperates with the opening of the shelf 28 to maintain the contact assembly 740 in position and to provide a stopping point to prevent over-inserting the plunger contact assembly 740 into the adjustable shelf 28.

FIG. 18 illustrates another exemplary contact assembly 840. The contact assembly 840 includes a leaf spring contact 850 and a mounting section 852 mounted in the shelf. In this exemplary embodiment, the leaf spring contact 850 extends outward from the side 43 of shelf 23 such that the spring contact 850 will resiliently engage the respective power strip as the shelf 23 is inserted into the cabinet. The contact assembly 850 is placed in electrical engagement with the lighting fixture as previously described with respect to the other embodiments.

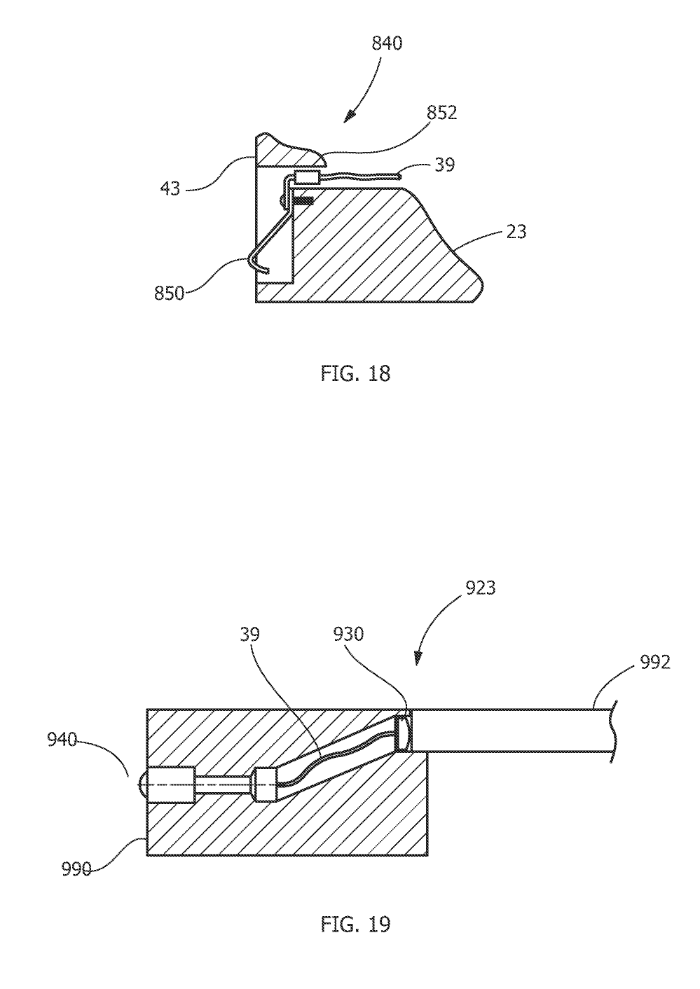

FIG. 19 illustrates an exemplary embodiment of a shelf 923. In this embodiment, the shelf 923 has a shelf frame 990 on which a glass portion 992 is seated. The lighting fixture 930 may be positioned in/on the shelf frame 990 and project light through the glass portion 992. Alternatively, the glass portion 992 may have lighting element provided therein which make contact with the contact assemblies 940 of the shelf frame 990 when the glass portion 992 is properly seated thereon.

The width of the adjustable lighted shelf 28 is only slightly less than the width of the interior opening of the cabinet 10. The non-compressed plunger contact assemblies 40, 340, 440, 540, 640, 740 protrude from the shelf and, therefore, the plunger contacts are resiliently compressed substantially when the shelf 28 is installed into the cabinet 10, thereby creating appropriate levels of contact normal force between the plunger contact assemblies 40, 340, 440, 540, 640, 740 and the power strips 20 to support the electric current flow with minimal interface resistance. In one exemplary embodiment the width of the shelf is about 0.12 inches less than the width of the interior opening of the cabinet, or more specifically, 0.06 inches less than the width of the interior opening of the cabinet, or even more specifically about 0.03 inches less than the width of the interior opening of the cabinet. The plunger contacts are compressed about 0.2 to 0.05 inches, or more specifically about 0.15 to 0.075 inches, or even more specifically, about 0.12 to 0.09 inches.

It will be apparent from the foregoing description and drawings that the various assemblies described cooperate to provide power from power supply to the lighting fixtures 30. Specifically, electrical current may flow from a power supply through a respective power strip 20 and the electrical contact assemblies 40, 340, 440, 540, 640, 740, when the contacts are in electrical engagement with the power strips, to the lighting fixtures 30. Current then returns via a similar path through the other contacts and power strip to the power supply, thereby completing an electrical circuit, and providing electrical energy for illuminating the light fixtures 30.

The exemplary embodiments described herein provide adjustable shelves which properly light and display items in the cabinet. Regardless of the position of the shelves in the cabinet, the properly inserted adjustable shelves provide appropriate light through the lighting fixtures which are mounted horizontally on the underside of each adjustable shelf. This is accomplished in an aesthetically pleasing matter while allowing the shelves to have a wide range of motion, including allowing the shelves to be removed and reinstalled in the cabinets without affecting the performance of the lighting fixtures.

The illustrative embodiments of the adjustable lighted shelves described above are suitable for many types of cabinets and displays. These include adjustable roll-out-shelves, adjustable shelves in a pull-out storage unit or any other applications in which movable or adjustable shelves require lighting thereon.

While the invention has been described with reference to a preferred embodiment, it will be understood by those skilled in the art that various changes may be made and equivalents may be substituted for elements thereof without departing from the scope of the invention. Such changes may include, but not be limited to, the use of different contacts or contact assemblies, such as the contact assemblies may be an integral component of the light fixture, or the use of different power strips. In addition, many modifications may be made to adapt a particular situation or material to the teachings of the invention without departing from the essential scope thereof. Dimensions included in the description are meant to be illustrative, rather than limiting. While the detailed description is directed to lighting in a cabinet, the principals of this invention may be used in other applications in which shelves are movable. Therefore, it is intended that the invention not be limited to the particular embodiment disclosed as the best mode contemplated for carrying out this invention, but that the invention will include all embodiments falling within the scope of the appended claims.

What is claimed is:

1. An adjustable shelf for mounting in a cabinet, the adjustable shelf comprising:
a top surface and a bottom surface, the bottom surface having a recess provided therein for receiving a lighting fixture, sidewalls extending between the top surface and the bottom surface, the sidewalls or back wall having openings which extend therethrough;
a lighting fixture mounted in the recess of the bottom surface;
contact assemblies mounted in the openings of the sidewalls or back wall, the contact assemblies being in electrical engagement with the lighting fixture, the contact assemblies having contacts which extend outward from the sidewalls or back wall and can be resiliently depressed toward the sidewalls or back wall as the adjustable shelf is positioned in a cabinet;
whereby the contact assemblies are independent of mounting means which mount the adjustable shelf to the cabinet, thereby providing unlimited position adjustability of the shelf without requiring intentional coupling or decoupling of electric power.

2. The adjustable shelf as recited in claim 1, wherein the contact assemblies comprising plunger contacts housed within contact housings, the plunger contacts being contained and permanently positioned in the contact housings.

3. The adjustable shelf as recited in claim 2, wherein the plunger contacts are retained in the contact housings by solder, the contact housings having stepped external profiles to cooperate with the surfaces of the recess to prevent over-inserting the contact assemblies into the adjustable shelf.

4. The adjustable shelf as recited in claim 1, wherein the contact assemblies comprising plunger contacts housed within contact housings, the plunger contacts having electrically conductive external members and electrically conductive internal members, resilient springs provided to bias the external members toward the sidewalls or back wall, the external members and the internal members being in electrical engagement, thereby allowing the power to be transmitted from the external members to the internal members.

5. The adjustable shelf as recited in claim 1, wherein the contact assemblies comprising plunger contacts housed within contact housings, the plunger contacts having electrically conductive external members and electrically conductive internal members, movable pins are provided to bias the external members toward the sidewalls or back wall, the external members the internal members are placed in electrical engagement by the engagement of the pins with the internal members, thereby allowing the power to be transmitted from the external members to the internal members.

6. The adjustable shelf as recited in claim 5, wherein the contact housings have shoulders to cooperate with the external members to contain and hold the external members in the contact housings.

7. The adjustable shelf as recited in claim 6, wherein the plunger contacts having shoulders to cooperate with the surfaces of the recess to prevent over-inserting the contact assemblies into the adjustable shelf.

8. The adjustable shelf as recited in claim 1, wherein the contact assemblies comprising plunger contacts housed within contact housings, the plunger contacts having a resilient springs provided to bias the plunger contacts toward the sidewalls or back wall, the contact housings having flared lips which cooperate with the openings of the shelf to maintain the contact assemblies in position and to provide over-inserting of the plunger contact assemblies into the adjustable shelf.

9. The adjustable shelf as recited in claim 1, wherein the contact assemblies comprising leaf spring contacts.

10. The adjustable shelf as recited in claim 1, wherein the contact assemblies are integrated in the lighting fixture.

11. The adjustable shelf as recited in claim 1, wherein the adjustable shelf is a roll out shelf.

12. The adjustable shelf as recited in claim 1, wherein the adjustable shelf is a pull out shelf.

13. The adjustable shelf as recited in claim 1, wherein the adjustable shelf includes a portion made of glass.

14. A cabinet having at least one adjustable shelf, the cabinet comprising:
power strips attached to a low voltage power supply;
shelf supports for mounting the at least one adjustable shelf in the cabinet;
the at least one adjustable shelf comprising;
a lighting fixture;
contact assemblies, the contact assemblies being in electrical engagement with the lighting fixture and the power strips, the contact assemblies having contacts which extend outward from the adjustable shelf to make electrical engagement with the power strips.

15. The cabinet of claim 14, wherein the contact assemblies are spring-loaded electrical plunger contact assemblies mounted in the at least one adjustable shelf so that only the movable portions of the plunger contact assemblies protrude from the at least one adjustable shelf.

16. The cabinet of claim 14, wherein two contact assemblies are provided on each respective at least one adjustable shelf, the power strips being mounted in the cabinet, the power strips being positioned to align to the placement of the contact assemblies when the at least one adjustable shelf is fully inserted into the cabinet.

17. The cabinet of claim 16, wherein the contact assemblies are positioned on either side of the at least one adjustable shelf.

18. The cabinet of claim 16, wherein the contact assemblies are positioned a same side of the at least one adjustable shelf.

19. The cabinet of claim 16, wherein the contact assemblies are positioned on a back side of the at least one adjustable shelf.

20. A cabinet having at least one adjustable shelf, the cabinet comprising:
power strips attached to a low voltage power supply;
shelf supports for mounting the at least one adjustable shelf in the cabinet;
the at least one adjustable shelf comprising;
a top surface and a bottom surface, the bottom surface having a recess provided therein for receiving a lighting fixture, sidewalls extending between the top surface and the bottom surface, the sidewalls or back wall having openings which extend therethrough;
a lighting fixture mounted in the recess of the bottom surface;
contact assemblies mounted in the openings of the sidewalls or back wall, the contact assemblies being in electrical engagement with the lighting fixture and the power strips, the contact assemblies having contacts which extend outward from the adjustable shelf to make electrical engagement with the power strips;
whereby the contact assemblies are independent of the shelf supports, thereby providing unlimited position adjustability of the at least one adjustable shelf without requiring intentional coupling or decoupling of electric power.

21. The cabinet of claim 20, wherein the contact assemblies are spring-loaded electrical plunger contact assemblies mounted in the at least one adjustable shelf so that only the movable portions of the plunger contact assemblies protrude from the at least one adjustable shelf.

22. The cabinet of claim 20, wherein two contact assemblies are provided on each respective at least one adjustable shelf, the power strips being mounted in a groove provided in the cabinet, the power strips being positioned to align to the placement of the contact assemblies when the at least one adjustable shelf is fully inserted into the cabinet.

23. The cabinet of claim 22, wherein the contact assemblies are positioned on either side of the at least one adjustable shelf.

24. The cabinet of claim 22, wherein the contact assemblies are positioned a same side of the at least one adjustable shelf.

25. The cabinet of claim 22, wherein the contact assemblies are positioned on a back side of the at least one adjustable shelf.
